(19) United States
(12) Patent Application Publication
(10) Pub. No.: US 2026/0127173 A1
(43) Pub. Date: May 7, 2026

(54) OUTLINE BINDING METHOD AND APPARATUS, AND STORAGE MEDIUM

(71) Applicant: BEIJING OCEANBASE TECHNOLOGY CO., LTD., Beijing (CN)

(72) Inventors: Guoyun LIU, Hangzhou (CN); Bin LIU, Hangzhou (CN); Yi XIAO, Hangzhou (CN); Wenjiao LIU, Hangzhou (CN); Lingyi LU, Hangzhou (CN)

(21) Appl. No.: 19/435,479

(22) Filed: Dec. 29, 2025

Related U.S. Application Data
(63) Continuation of application No. PCT/CN2024/126728, filed on Oct. 23, 2024.

(30) Foreign Application Priority Data
Nov. 30, 2023 (CN) 202311630489.6

(51) Int. Cl. G06F 16/2453

(52) U.S. Cl. CPC G06F 16/24542

(57) ABSTRACT

The present specification provides an outline binding method and apparatus, and a storage medium. The method includes: obtaining a query statement; generating a formatted query statement corresponding to the query statement; determining a target outline that matches the formatted query statement from at least one first-type outline, the first-type outline being a formatted outline to which a plurality of query statements capable of being normalized are jointly bound; and generating a plan corresponding to the query statement by using the target outline. The present specification allows a plurality of query statements to be jointly bound to a formatted outline, thereby implementing binding of a formatted outline without a need to modify service logic, improving flexibility of outline binding, and ensuring correctness and reliability of outline effectiveness.

### TECHNICAL FIELD

One or more implementations of the present specification relate to the field of database processing technologies, and in particular, to an outline binding method and apparatus, and a storage medium.

### BACKGROUND

Currently, in a process of executing certain services, if there are too many IN queries used to search a database for specified values, a problem that a central processing unit of a database server is excessively occupied may be caused, which may further make services be not executable. A manner of adjusting primary and standby nodes of a single table needs to be used for temporary mitigation.

### SUMMARY

According to a first aspect of one or more implementations of the present specification, an outline binding method is provided, including: obtaining a query statement; generating a formatted query statement corresponding to the query statement; determining a target outline that matches the formatted query statement from at least one first-type outline, the first-type outline being a formatted outline to which a plurality of query statements capable of being normalized are jointly bound; and generating a plan corresponding to the query statement by using the target outline.

According to a second aspect of one or more implementations of the present specification, an outline binding apparatus is provided, including: an acquisition module, configured to obtain a query statement; a generation module, configured to generate a formatted query statement corresponding to the query statement; a determining module, configured to determine a target outline that matches the formatted query statement from at least one first-type outline, the first-type outline being a formatted outline to which a plurality of query statements capable of being normalized are jointly bound; and an execution module, configured to generate a plan corresponding to the query statement by using the target outline.

According to a third aspect of one or more implementations of the present specification, a server is provided, including: a processor; and a storage, configured to store processor-executable instructions. The processor runs the executable instructions to implement the outline binding method according to any one of the above implementations.

According to a fourth aspect of one or more implementations of the present specification, a computer-readable storage medium is provided. The computer-readable storage medium stores computer instructions, and when the instructions are executed by a processor, the steps of the outline binding method according to any one of the above implementations are implemented.

The technical solutions provided in the implementations of the present specification can include the following beneficial effects.

In the present specification, a plurality of query statements can be jointly bound to a formatted outline, thereby implementing binding of a formatted outline without a need to modify service logic, improving flexibility of outline binding, and ensuring correctness and reliability of outline effectiveness.

### BRIEF DESCRIPTION OF DRAWINGS

FIG. 1 is a flowchart illustrating an outline binding method according to an example implementation;

FIG. 2 is a flowchart illustrating another outline binding method according to an example implementation;

FIG. 3A is a flowchart illustrating another outline binding method to an example implementation;

FIG. 3B is a flowchart illustrating another outline binding method according to an example implementation;

FIG. 4 is a block diagram illustrating an outline binding apparatus according to an example implementation; and

FIG. 5 is a schematic structural diagram illustrating a server according to an example implementation.

### DESCRIPTION OF EMBODIMENTS

Example implementations are described in detail herein, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations consistent with one or more implementations of the present specification. On the contrary, the implementations are merely examples of apparatuses and methods consistent with some aspects of one or more implementations of the present specification described in detail in the appended claims.

It should be noted that, in other implementations, the steps of the corresponding method are not necessarily performed in the sequence shown and described in the present specification. In some other implementations, the method can include more or fewer steps than those described in the present specification. In addition, a single step described in the present specification may be broken down into a plurality of steps in other implementations for description, and a plurality of steps described in the present specification may be combined into a single step in other implementations for description.

Before describing the solution of the present specification, the terms involved in the present specification are first described.

Parameterization: a process of removing a constant in a structured query language (SQL) syntax tree based on certain rules when the syntax tree is processed.

Query statement identifier (SQL-ID): a message digest algorithm 5 (MD5) value calculated by using text obtained after text of a SQL statement is parameterized.

Outline: a mechanism for controlling an execution plan for a SQL statement based on a hint.

Outline binding: a common manner for stabilizing a plan.

Formatted outline binding: a mechanism capable of controlling execution plans for a plurality of SQL statements simply by specifying a single rule.

Hint: information used to guide plan generation.

Currently, if a number of IN queries is not limited, an outline cannot be better bound. An example is provided below for description:

It is assumed that there are three SQL statements:
1. select * from A where col in(1,2);
2. select * from A where col in(1,2,3);
3. select * from A where col in(1,2,3,4).

After the above three SQL statements are parameterized, the following statements are obtained:
select * from A where col in(?,?);
select * from A where col in(?,?,?);
select * from A where col in(?,?,?,?).

If outline binding is to be performed on the above three SQL statements, an outline needs to be created for each SQL statement. Obviously, this manner is inefficient and consumes time and effort.

Currently, the following approaches can be used for outline binding:

### Approach 1: Temporary Table Method

A basic idea thereof is to insert an IN constant into a temporary table and then modify a right branch of IN in the SQL syntax tree to a sub-query. For example, this approach can include the following implementation solutions:

### A. Using Bind Variables

When an outline is created, a name of a bind variable is used to replace a constant value, as shown below:

CREATE OUTLINE my_outline FOR SELECT * FROM my_table WHERE column1 IN
(:list).

As such, when the above SQL statements are used, my_outline can be used to optimize a query plan, and a value in the bind variable can be passed to my_outline to replace a constant value in an IN clause.

```
  B. ANY operator
  DO $$
  DECLARE
    sql_stmt text := ‘SELECT * FROM my_table WHERE my_column = ANY($1)’;
  BEGIN
    -- Store the query plan in OUTLINE
    SELECT pg_create_logical_replication_slot(‘my_outline’);
    SELECT pg_create_physical_replication_slot(‘my_outline’);
    EXECUTE ‘EXPLAIN (FORMAT JSON) ’ || sql_stmt INTO @my_plan;
    PERFORM pg_replication_origin_xact_setup(‘my_outline’);
    PERFORM pg_logical_emit_message(CAST(@my_plan AS TEXT), NULL,
‘my_outline’);
  END;
  $$;
  --
  expression operator ANY (array expression)
```

### C. PS-Like Protocol

Prepared statements and execute statements are used to share a SQL execution plan when a number of IN constants is not limited. Example steps are as follows.

Use a prepared statement to define a placeholder, and replace a constant in an IN clause with the placeholder, as shown below:
PREPARE my_query FROM ‘SELECT * FROM my_table WHERE my_column IN (?)’.

Use an execute statement to execute a query and pass a value of the constant into the placeholder.

EXECUTE my_query USING (1, 2, 3, 4, 5);
approaches used in Starrocks/Doris/Impala/Spark.

### Approach 2: Array Method

This approach can extract the right branch of IN in the SQL syntax tree as an array, but extraction manners for various databases can be different.

In Approach 2, the query can be rewritten to query a temporary table:

First, a temporary table can be created, and a constant in an IN clause is inserted into the temporary table.

CREATE GLOBAL TEMPORARY TABLE temp_table (col1 NUMBER);
INSERT INTO temp_table(col1) SELECT column_value
FROM TABLE(SYS.ODCINUMBERLIST(1,2,3,4,5)).

Second, a JOIN operation is used to connect the temporary table to a main query statement.
SELECT * FROM my_table WHERE my_column IN (SELECT col 1 FROM temp_table).

However, each of the above approaches needs to modify service logic, resulting in relatively high outline binding costs.

The present specification provides an outline binding method and apparatus, and a storage medium below, which, among others, better bind an outline when the number of IN queries is not limited, without modifying a service logic. This allows a plurality of query statements to be jointly bound to a formatted outline, thereby implementing binding of a formatted outline without a need to modify service logic, improving flexibility of outline binding, and ensuring correctness and reliability of outline effectiveness.

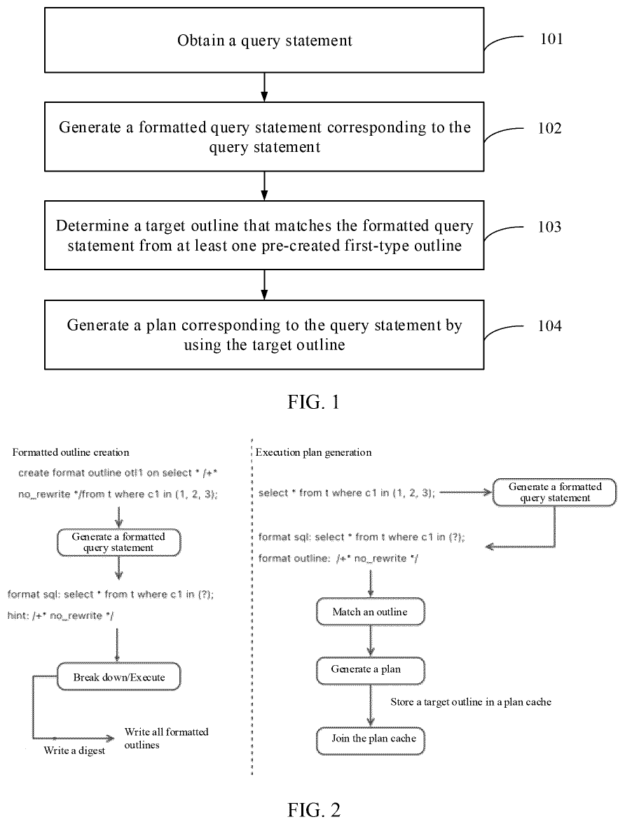

FIG. 1 is a flowchart illustrating an outline binding method according to an example implementation. Referring to FIG. 1, the method can be executed by a server. Specifically, the server can be a server on which a database is deployed. The database can support at least one type of query statement, including but not limited to a SQL statement. A SQL statement is used as an example below for description, but the solution of the present specification is not limited by a scenario in which the database uses a SQL statement. The method includes step 101 to step 104.

In step 101, a query statement is obtained.

In the present specification, when a plan is to be generated, a corresponding query statement can be obtained.

For example, the query statement is “select * from t where c1 in(1,2,3)”.

In step 102, a formatted query statement corresponding to the query statement is generated.

In an implementation of the present specification, the formatted query statement corresponding to the query statement can be generated. For example, the query statement can be parameterized to obtain the formatted query statement.

For example, the query statement is “select * from t where c1 in(1,2,3)”, and the formatted query statement is “select * from t where c1 in(?)”.

In step 103, a target outline that matches the formatted query statement is determined from at least one first-type outline, e.g., pre-created.

In the present specification, the first-type outline and the formatted outline can be interchangeably.

In the implementation of the present specification, the first-type outline is a formatted outline to which a plurality of query statements capable of being normalized are jointly bound. “Capable of being normalized” means that parameters in the query statements are folded. Because the plurality of query statements capable of being normalized have similar parameter patterns, parameters of the plurality of query statements can be folded.

For example, select * from A where col in(?,?);
select * from A where col in(?,?,?);
select * from A where col in(?,?,?,?).

Because the above three query statements have similar parameter patterns, the three query statements can be normalized. A query statement obtained after normalization is “select * from A where col in(?)”.

In the implementation of the present specification, the plurality of query statements capable of being normalized can be jointly bound to an outline. The outline is referred to as a formatted outline, i.e., the first-type outline.

In an example, if the plurality of query statements cannot be normalized, but a syntax similarity of the plurality of query statements reaches or exceeds a set threshold, e.g., preset, these query statements can also be bound to a formatted outline. The formatted outline is the first-type outline.

The present specification is not limited by whether the plurality of query statements can be normalized, or whether the syntax similarity of the plurality of query statements reaches or exceeds the set threshold. For example, the plurality of query statements cannot be normalized and have a relatively low syntax similarity (assumed to be below the set threshold), but to reduce the number of IN queries or other queries (e.g., select, from, and where), these query statements can also be bound to a same formatted outline.

In an example, one or more first-type outlines can be created by using, but not limited to, any of following manners.

### Manner 1: Create at Least One First-Type Outline Based on Formatted Query Text.

The formatted query text can refer to “format sql-text”. “sql-text” refers to an original SQL statement with parameters that is executed by a user.

For example, a creation syntax of the outline is as follows:

/* Create Outline using SQL_TEXT */
CREATE [OR REPLACE] FORMAT OUTLINE outline_name ON stmt [ TO target_stmt ]

“outline_name” refers to a name of the created outline.

“stmt” refers to a first formatted query statement, and the first formatted query statement is not bound to a hint. “target_stmt” refers to a second formatted query statement, and the second formatted query statement is bound to the hint.

In an example, the first-type outline can include the hint and the first formatted query statement. For example, CREATE [OR REPLACE] FORMAT OUTLINE outline_name ON stmt.

In an example, the first-type outline can include the hint, the first formatted query statement, and the second formatted query statement. For example, CREATE [OR REPLACE] FORMAT OUTLINE outline_name ON stmt TO target_stmt.

In this case, only a query statement including the hint can use the first-type outline.

It should also be noted that the first formatted query statement and the second formatted query statement with the hint removed should exactly match.

For example, a first-type outline is created:
create format outline otl1 on select */+* no_rewrite */from t where c1 in(1,2,3).

The first formatted query statement is: select * from t where c1 in(1,2,3), and the hint is: /*+no_rewrite */.

### Manner 2: Create at Least One First-Type Outline Based on a Formatted Query Statement Identifier.

A creation syntax of the outline is as follows:

```
  /* Create Outline using SQL_ID */
  CREATE [OR REPLACE] FORMAT OUTLINE outline_name ON format_sql_id
USING HINT hint.
```

“outline_name” refers to a name of the created outline.

“format_sql_id” refers to a formatted query statement identifier, which can be obtained in the following manner: querying a table to obtain a query statement identifier corresponding to the above first formatted query statement or the above second formatted query statement, and determining the queried query statement identifier as the formatted query statement identifier.

For example, the table can include, but is not limited to, at least one of following tables:

a sql audit view (gv$ob_sql_audit) table; or
a sql execution plan cache view (gv$ob_plan_cache_plan_stat) table.

Correspondingly, the first-type outline includes the hint and the formatted query statement identifier.

In an example, the following manner can be used to determine a target outline that matches the formatted query statement from at least one first-type outline.

### Manner 1: Create the First-Type Outline Based on Formatted Query Text, a Query Statement not Including a Hint.

The server can determine, from the first-type outline that does not include the second formatted query statement, an outline that matches the formatted query statement as the target outline.

For example, the formatted query statement is “select * from t where c1 in(?)”. A matched first-type outline that does not include the second formatted query statement is “otl1”. The server can determine “otl1” as the target outline.

### Manner 2: Create the First-Type Outline Based on Formatted Query Text, a Query Statement Including a Hint.

The server can determine, from the first-type outline that includes the second formatted query statement, a first-type outline that matches the formatted query statement as the target outline.

### Manner 3: Create the First-Type Outline Based on a Formatted Query Statement Identifier.

The server can query a table to obtain a formatted query statement identifier corresponding to the formatted query statement, and then determine a first-type outline corresponding to the formatted query statement identifier as the target outline.

The table includes, but is not limited to, at least one of following:

a sql audit view (gv$ob_sql_audit) table; or
a sql execution plan cache view (gv$ob_plan_cache_plan_stat) table.

In step 104, a plan corresponding to the query statement is generated by using the target outline.

In the implementation of the present specification, after the server determines the target outline, the plan can be generated by using the target outline, and the target outline is stored in a plan cache, so that the generated plan is executed.

In the above implementation, the plurality of query statements capable of being normalized can be jointly bound to a formatted outline, thereby implementing binding of a formatted outline without a need to modify service logic, improving flexibility of outline binding, and ensuring correctness and reliability of outline effectiveness.

In some implementations, referring to FIG. 2, it is assumed that a statement for creating the first-type outline is as follows:
create format outline otl1 on select */+* no_rewrite */from t where c1 in(1,2,3).

The server can extract the first formatted query statement in the statement: select * from t where c1 in(1,2,3), and extract a hint in the statement: /*+no_rewrite */.

The above outline is written to all formatted outlines (the first-type outlines).

After the query statement “select * from t where c1 in(1,2,3)” is obtained, a corresponding formatted query statement “select * from t where c1 in(?)” is generated, and then a target outline that matches the formatted query statement is determined from all formatted outlines (the first-type outlines). A plan is generated based on the target outline, and the target outline is stored in a plan cache.

In the above implementation, the plurality of query statements capable of being normalized can be jointly bound to a formatted outline, thereby implementing binding of a formatted outline without a need to modify service logic, improving flexibility of outline binding, and ensuring correctness and reliability of outline effectiveness.

In some implementations, one or more of the created formatted outlines (the first-type outlines) can be dropped.

A dropping syntax of the outline is as follows:
DROP FORMAT OUTLINE outline_name.

After the first-type outline is dropped, the SQL statement will no longer rely on the dropped first-type outline when regenerating a plan.

In the above implementation, flexibility of outline creation and dropping is improved, thereby ensuring correctness and reliability of outline effectiveness.

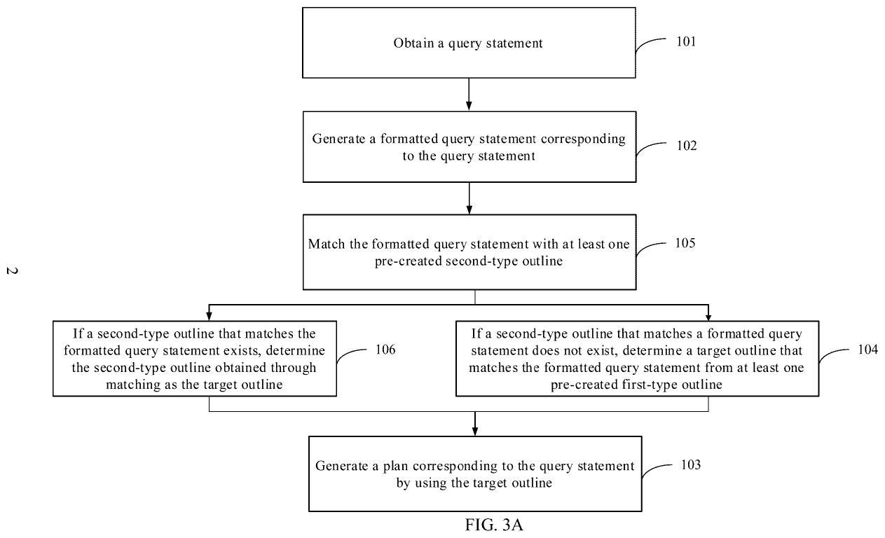

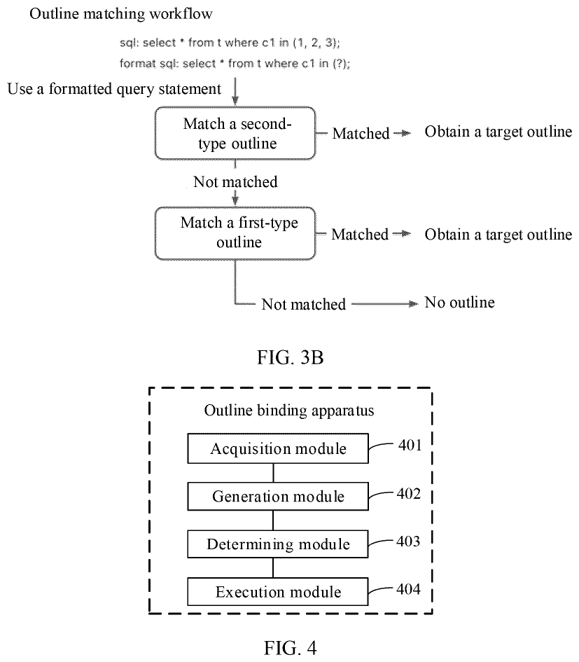

In some implementations, FIG. 3A is a flowchart illustrating another outline binding method according to the implementation shown in FIG. 1. Referring to FIG. 3A, the method further includes steps S105 and S106.

In step 105, the formatted query statement is matched with at least one second-type outline, e.g., pre-created.

The second-type outline is an outline bound to a query statement in a one-to-one manner. It can be understood that each second-type outline is bound to a query statement and is a precise outline corresponding to the query statement. The second-type outline can be understood as a traditional outline that is different from the formatted outline.

In step 106, if a second-type outline that matches the formatted query statement exists, the second-type outline obtained through matching is determined as the target outline.

Further, step 104 of generating the plan corresponding to the query statement by using the target outline described above can continue to be performed.

In step 106, if a second-type outline that matches the formatted query statement does not exist, step 103 of determining the target outline that matches the formatted query statement from the at least one first-type outline described above is performed.

For example, select * from t where c1 in(1,2);
select * from t where c1 in (1, 2, 3);
select * from t where c1 in (1, 2, 3, 4).

The three SQL statements share a first-type outline, i.e., otl1. sql #2 corresponds to a second-type outline, i.e., otl2.

Referring to FIG. 3B, after obtaining the query statement and generating the corresponding formatted query statement, the server may match the second-type outline. If no second-type outline is matched, the server matches the first-type outline. If there is no first-type outline, it is determined that there is no outline.

In the above implementation, through compatibility processing for a traditional outline, correctness and reliability of outline effectiveness are ensured, and flexibility of outline binding is enhanced.

Referring to FIG. 4, an outline binding apparatus can be applied to a server, such as a server on which a database is deployed, to implement the technical solution of the present specification. The outline binding apparatus can include: an acquisition module 401, configured to obtain a query statement; a generation module 402, configured to generate a formatted query statement corresponding to the query statement; a determining module 403, configured to determine a target outline that matches the formatted query statement from at least one first-type outline, the first-type outline being a formatted outline to which a plurality of query statements capable of being normalized are jointly bound; and an execution module 404, configured to generate a plan corresponding to the query statement by using the target outline.

The systems, apparatuses, modules, or units described in the above implementations can be specifically implemented by a computer chip or an entity, or can be implemented by a product having a certain function. An example implementation device is a computer, and a specific form of the computer can be a personal computer, a laptop computer, a cellular phone, a camera phone, a smartphone, a personal digital assistant, a media player, a navigation device, an email receiving/sending device, a game console, a tablet computer, a wearable device, or any combination of several devices in these devices.

In an example configuration, the computer includes one or more central processing units (CPU), input/output interfaces, network interfaces, and memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory can include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic disk storage, a quantum memory, a graphene-based storage medium, another magnetic storage device, or any other non-transmission medium. The computer storage medium can be configured to store information that can be accessed by a computing device. As described in the present specification, the computer-readable medium does not include computer-readable transitory media such as a modulated data signal and a carrier.

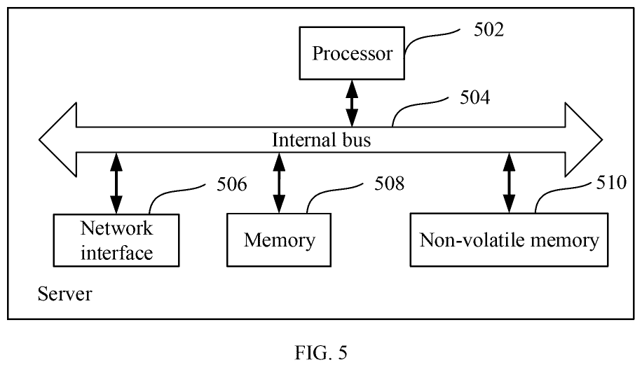

FIG. 5 is a schematic structural diagram illustrating a server according to an example implementation. Referring to FIG. 5, in terms of hardware, the device includes a processor 502, an internal bus 504, a network interface 506, a memory 508, and a non-volatile memory 510, and certainly may further include hardware for another service. One or more implementations of the present specification can be implemented in a software-based manner. For example, the processor 502 reads a corresponding computer program from the non-volatile memory 510 into the memory 508, and then runs the computer program. Certainly, in addition to a software implementation, one or more implementations of the present specification do not exclude another implementation, for example, a logic device or a combination of hardware and software. That is, an execution body of the following processing procedure is not limited to each logical unit, and can be hardware or a logic device.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

Specific implementations of the present specification are described above. Other implementations are also possible and fall within the scope of the appended claims. In some cases, the actions or steps described in the claims can be performed in a sequence different from that in the implementations and the desired results can still be achieved. In addition, the process depicted in the accompanying drawings does not necessarily need a particular sequence or a consecutive sequence to achieve the desired results. In some implementations, multi-tasking and parallel processing are feasible or may be advantageous.

The terms used in one or more implementations of the present specification are merely used to describe example implementations, and are not intended to limit the one or more implementations of the present specification. The terms “a” and “the” of singular forms used in one or more implementations of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. may be used in one or more implementations of the present specification to describe various types of information, the information should not be limited to these terms. These terms are merely used to distinguish between information of the same type. For example, without departing from the scope of one or more implementations of the present specification, first information can also be referred to as second information, and similarly, the second information can also be referred to as the first information. Depending on the context, for example, the word “if” used herein can be explained as “while”, “when”, or “in response to determining”.

The above descriptions are merely example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

What is claimed is:

1. A method, comprising:
obtaining a query statement;
generating a formatted query statement corresponding to the query statement;
determining a target outline that matches the formatted query statement from at least one first-type outline, a first-type outline of the at least one first-type outline being a formatted outline to which a plurality of query statements capable of being normalized are jointly bound; and
generating a plan corresponding to the query statement by using the target outline.

2. The method according to claim 1, further comprising one or more of:
creating the at least one first-type outline based on formatted query text; or
creating the at least one first-type outline based on a formatted query statement identifier.

3. The method according to claim 1, wherein the first-type outline includes at least one of:
a hint;
a first formatted query statement, the first formatted query statement being not bound to a hint;
a second formatted query statement, the second formatted query statement being bound to a hint; or
a formatted query statement identifier.

4. The method according to claim 3, further comprising:
querying a table to obtain a query statement identifier corresponding to the first formatted query statement or the second formatted query statement; and
determining the query statement identifier obtained as the formatted query statement identifier.

5. The method according to claim 3, wherein the determining the target outline that matches the formatted query statement includes one or more of:
in response to that the at least one first-type outline is created based on formatted query text and the query statement does not include a hint, determining, from a first-type outline that does not include the second formatted query statement, a first-type outline that matches the formatted query statement as the target outline; or
in response to that the at least one first-type outline is created based on the formatted query text and the query statement includes a hint, determining, from a first-type outline that includes the second formatted query statement, a first-type outline that matches the formatted query statement as the target outline.

6. The method according to claim 3, wherein the determining the target outline that matches the formatted query statement includes:
querying a table to obtain a formatted query statement identifier corresponding to the formatted query statement; and
determining a first-type outline corresponding to the formatted query statement identifier obtained as the target outline.

7. The method according to claim 1, further comprising:
matching the formatted query statement with at least one second-type outline, the second-type outline being an outline bound to a query statement in a one-to-one manner;
in response to that a second-type outline that matches the formatted query statement exists, determining the second-type outline that matches the formatted query statement as the target outline, and generating the plan by using the second-type outline that matches the formatted query statement; and
in response to that a second-type outline that matches the formatted query statement does not exist, determining the target outline from the at least one first-type outline.

8. A server, comprising:
one or more processors; and
one or more storage devices, individually or collectively, having processor-executable instructions stored thereon, the processor-executable instructions, when executed by the one or more processors, enabling the one or more processors to, individually or collectively, implement actions including:
obtaining a query statement;
generating a formatted query statement corresponding to the query statement;
determining a target outline that matches the formatted query statement from at least one first-type outline, a first-type outline of the at least one first-type outline being a formatted outline to which a plurality of query statements capable of being normalized are jointly bound; and
generating a plan corresponding to the query statement by using the target outline.

9. The server according to claim 8, wherein the actions include one or more of:
creating the at least one first-type outline based on formatted query text; or
creating the at least one first-type outline based on a formatted query statement identifier.

10. The server according to claim 8, wherein the first-type outline includes at least one of:
a hint;
a first formatted query statement, the first formatted query statement being not bound to a hint;
a second formatted query statement, the second formatted query statement being bound to a hint; or
a formatted query statement identifier.

11. The server according to claim 10, wherein the actions include:
querying a table to obtain a query statement identifier corresponding to the first formatted query statement or the second formatted query statement; and
determining the query statement identifier obtained as the formatted query statement identifier.

12. The server according to claim 10, wherein the determining the target outline that matches the formatted query statement includes one or more of:
in response to that the at least one first-type outline is created based on formatted query text and the query statement does not include a hint, determining, from a first-type outline that does not include the second formatted query statement, a first-type outline that matches the formatted query statement as the target outline; or
in response to that the at least one first-type outline is created based on the formatted query text and the query statement includes a hint, determining, from a first-type outline that includes the second formatted query statement, a first-type outline that matches the formatted query statement as the target outline.

13. The server according to claim 10, wherein the determining the target outline that matches the formatted query statement includes:
querying a table to obtain a formatted query statement identifier corresponding to the formatted query statement; and
determining a first-type outline corresponding to the formatted query statement identifier obtained as the target outline.

14. The server according to claim 8, wherein the action include:
matching the formatted query statement with at least one second-type outline, the second-type outline being an outline bound to a query statement in a one-to-one manner;
in response to that a second-type outline that matches the formatted query statement exists, determining the second-type outline that matches the formatted query statement as the target outline, and generating the plan by using the second-type outline that matches the formatted query statement; and
in response to that a second-type outline that matches the formatted query statement does not exist, determining the target outline from the at least one first-type outline.

15. A computer-readable storage medium having computer instructions stored thereon, the computer instructions, when executed by one or more processors, enabling the one or more processors to, individually or collectively, implement actions including:
obtaining a query statement;
generating a formatted query statement corresponding to the query statement;
determining a target outline that matches the formatted query statement from at least one first-type outline, a first-type outline of the at least one first-type outline being a formatted outline to which a plurality of query statements capable of being normalized are jointly bound; and
generating a plan corresponding to the query statement by using the target outline.

16. The computer-readable storage medium according to claim 15, wherein the actions include one or more of:
creating the at least one first-type outline based on formatted query text; or
creating the at least one first-type outline based on a formatted query statement identifier.

17. The computer-readable storage medium according to claim 15, wherein the first-type outline includes at least one of:
a hint;
a first formatted query statement, the first formatted query statement being not bound to a hint;
a second formatted query statement, the second formatted query statement being bound to a hint; or
a formatted query statement identifier.

18. The computer-readable storage medium according to claim 17, wherein the actions include:
querying a table to obtain a query statement identifier corresponding to the first formatted query statement or the second formatted query statement; and
determining the query statement identifier obtained as the formatted query statement identifier.

19. The computer-readable storage medium according to claim 17, wherein the determining the target outline that matches the formatted query statement includes one or more of:
in response to that the at least one first-type outline is created based on formatted query text and the query statement does not include a hint, determining, from a first-type outline that does not include the second formatted query statement, a first-type outline that matches the formatted query statement as the target outline; or
in response to that the at least one first-type outline is created based on the formatted query text and the query statement includes a hint, determining, from a first-type outline that includes the second formatted query statement, a first-type outline that matches the formatted query statement as the target outline.

20. The computer-readable storage medium according to claim 17, wherein the determining the target outline that matches the formatted query statement includes:
querying a table to obtain a formatted query statement identifier corresponding to the formatted query statement; and
determining a first-type outline corresponding to the formatted query statement identifier obtained as the target outline.
